(19) United States
(12) Patent Application Publication
(10) Pub. No.: US 2013/0310153 A1
(43) Pub. Date: Nov. 21, 2013

(54) CONTENT-BASED ELECTRONIC COMPETITIONS

(71) Applicant: Charles Shelby Goerlitz, Bainbridge Island, WA (US)

(72) Inventor: Charles Shelby Goerlitz, Bainbridge Island, WA (US)

(21) Appl. No.: 13/875,111

(22) Filed: May 1, 2013

Related U.S. Application Data
(60) Provisional application No. 61/641,186, filed on May 1, 2012.

(51) Int. Cl. A63F 13/00

(52) U.S. Cl. CPC A63F 13/00
USPC 463/25; 463/31

(57) ABSTRACT

Publishers of content are provided access to systems that enable the publishers to present electronic competitions in connection with their content. Publishers design the electronic competitions and sponsors are matched. Consumers access the electronic competitions through various access points. Social networking tools are used to facilitate the interactions among the various participants in creating, sponsoring, managing, and playing electronic competitions.

### CROSS-REFERENCE

This application claims the benefit of U.S. Provisional Application No. 61/641,186, filed May 1, 2012, which application is incorporated herein by reference.

### BACKGROUND OF THE INVENTION

Modern communications networks allow users to interact with one another in numerous ways. Content publishers can easily distribute content to consumers. Advertisers can promote their goods and/or services to relevant consumers, often in ways where the advertisers' costs are tied to the effectiveness of the advertisements. Social networking systems allow users to interact with one another in a semi-public way where communications are more relevant to the various users than they would be if they were publicly broadcast, but at the same time, easier than more private ways of communicating, such as through electronic mail. While various systems for utilizing modern communications networks have, in general, enabled numerous communications among various participants, numerous challenges remain.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a diagrammatic representation of a cycle of electronic competition, in accordance with at least one embodiment;

FIG. 2 shows a diagrammatic representation of interaction between various entities involved in electronic competitions, in accordance with at least one embodiment;

FIG. 3 shows an illustrative example of an interface page for creating a new game, in accordance with at least one embodiment;

FIG. 4 shows an illustrative example of an interface page for creating bets for a game, in accordance with at least one embodiment;

FIG. 5 shows an illustrative example of an interface page that shows a summary of a game, in accordance with at least one embodiment;

FIG. 6 shows an illustrative example of an interface page that provides code for providing access to an entry point to an electronic competition, in accordance with at least one embodiment;

FIG. 7 shows an illustrative example of an interface page that allows a sponsor to sponsor an electronic competition, in accordance with at least one embodiment;

FIG. 8 shows an illustrative example of an interface that allows a sponsor to manage rewards for sponsorship of an electronic competition, in accordance with at least one embodiment;

FIG. 9 shows illustrative examples of presentations of access to entry points to electronic competitions, in accordance with at least one embodiment;

FIG. 10 shows illustrative examples of presentation of electronic competitions, in accordance with at least one embodiment;

FIG. 11 shows an illustrative example of a content page dedicated to an electronic competition, in accordance with at least one embodiment; and

FIG. 12 shows an illustrative example of a computer system that may be used to implement various aspects of the present disclosure, in accordance with at least one embodiment.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Techniques described and suggested herein relate generally to electronic competitions, such as prediction games, based on Internet content of third-party publishers. Systems and methods for conducting electronic competitions, in various embodiments, are designed to enhance consumer engagement for content publishers by offering a number of electronic competitions to be played by the publisher's readers/consumers and their friends, acquaintances, and others and frequently with the content author.

For a particular consumer, the consumer's friends may be made up of people in that consumer's social graph, where a social graph for a consumer is a collection of nodes and vertices connecting the nodes, where the nodes represent individuals (or possibly non-human entities), at least one node represents the consumer, and where nodes are directly connected to one another based at least in part on some criteria, such as mutual agreement on the connection. As an example, a consumer's social graph may be the collection of nodes that are connected to the consumer's node directly by a vertex, although other social graphs are considered as being within the scope of the present disclosure, such as a collection of nodes within a particular graph-theoretical distance of the consumer's node. Social graphs may be generated in connection with the operation of social networking organizations. For example, a social networking organization may operate one or more data centers that support systems that allow users of the systems to interact with one another in an electronic environment, such as on a web page and/or through mobile applications that communicate electronically with the systems.

Content for electronic competitions, in an embodiment, is generated by the third-party publisher using tools provided by a facilitator of the electronic competitions, where the facilitator may be an entity that operates its own systems to support competitions that are embedded into third-party publisher content. While the content may have a primary purpose as an engagement vehicle for the publisher, the corresponding competition content may be re-used—with linkbacks to the original content intact—for additional competitions (perhaps sponsored), as in the case where another person or publisher creates a competition and finds new sponsorship for existing competition content. For example, a small blogger may create a Superbowl proposition bet game based on bets published by other sports publishers and may use a separate sponsor to award a prize for that newly bundled game.

Electronic competitions may be played for promotional prizes, including badges, achievements, as well as promotional currencies. Some of the prizes may be offered directly by a facilitator of the electronic competitions, some may be offered by third-party sponsors (such as advertisers) and may be integrated directly into competition participation. In an embodiment, sponsored prizes are calculated to be topically relevant, with prize and currency sponsorships sold where the sponsor has the strongest natural affinity to the content. Generally, the overall design of a competition facilitator system may be to provide electronic competitions that attract consumer-players that have a high affinity for the publisher and sponsor content, and that the publishers and sponsors not only engage their consumers, but also their consumers' social graphs.

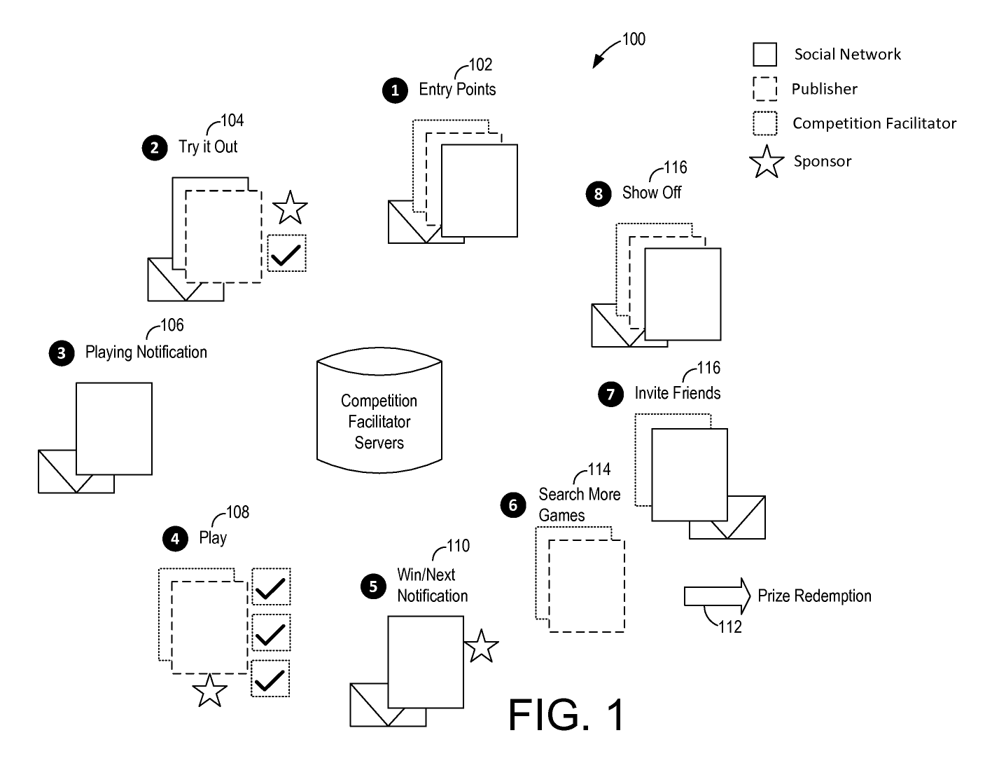

As noted, embodiments of the present disclosure include techniques for facilitating participation in electronic competitions. FIG. 1 shows a diagram illustrating an example of a consumer engagement lifecycle 100 in accordance with an embodiment. As shown in FIG. 1, embodiments of the present disclosure involve multiple participants, including consumers, social network companies, publishers, competition facilitators, and sponsors. Such participants (and possibly others) may participate through corresponding computer systems. For example, consumers may participate through electronic devices such as personal computers, mobile communication devices, tablet computers, and/or other devices. In addition, participants may participate through more complex systems which may include networks of computing devices. For example, any participant may utilize one or more servers, data stores, network devices, and other components in performing its role. It should be noted that, unless otherwise clear from context, when various actions are described as being performed by one or more participants, such participation occurs through the corresponding systems. For example, a publisher providing content to a consumer may include a web server of the publisher sending, over a communications network such as the Internet, an electronic document containing the content to a computer system operated by the user.

At each point in the lifecycle, different participants play different roles. For example, beginning with the state 102 indicated by the number “1,” consumers may become participants in a variety of ways. For example, as illustrated, consumers may find entry points to participation through social network systems, publisher content, electronic mail, and in other ways. An entry point may be a user interface (such as a graphical user interface) that enables a user to become a participant. The entry points may be, for instance, social networking applications, mobile device applications, web pages, links to web pages, and the like. Entry points may also be embedded into content, applications, advertisements, and the like. Entry points may include mechanisms, such as forms or links to forms, where users can provide any data required for participation and/or otherwise fulfill any participation requirements, which may include permissions for accessing user information from another system, such as a social network system. Generally, entry points may be any interface that allows user participation, which may vary according to the various embodiments contemplated as being within the scope of the present disclosure.

Once having engaged with an entry point 104, as indicated by the number “2,” in an embodiment, a consumer may participate in competitions in order to gain familiarity with the competitions. Participation may come in many forms—for example, in an embodiment, a content widget provided to users in connection with content. The widget may, for example, be embedded into a web page accessed by the user. The widget may be an interactive interface for engaging in an electronic competition, as discussed below. Participation, in various embodiments, may also occur through web pages whose primary content is the electronic competition, applications, and the like, some examples of which are described in more detail below. As illustrated in FIG. 1, at numeral “2,” numerous entities may participate in addition to consumers themselves. For example, in an embodiment where an electronic competition is presented in connection with content, a publisher may provide the content and a competition facilitator may provide a widget to be included with the content. A sponsor, such as an advertiser, may provide some sort of reward for one or more winners of a competition. Example rewards include, money, discounts and other deals, points redeemable for various items, electronic badges, medals, trophies, and other rewards, and the like. For instance, a restaurant company may provide winners of competitions with coupons that are redeemable for free or discounted food.

Turning to item “3” in FIG. 1, when a consumer participates, various notifications may be made 106. For example, in a social networking context, a member of a social network may participate in a game. Participation in the game may trigger an event in a social networking system that may cause various things to happen. For instance, some social networks utilize the concept of a “wall” where various status updates, comments, and other information appear. A notification may appear on such a wall. Other members of the social network may also receive notifications of the consumer's participation in a competition. For example, members of a social network may mutually link their accounts to one another by, for example, mutually providing confirmation that the users are friends of one another. Accounts linked to one another may be said to be linked to one another or the users may be said to be linked to one another. When one user participates in an electronic competition, members that are directly linked to the participating user may receive an electronic notification, such as a wall post, an email or other electronic message (such as an electronic message through a social network messaging system), an instance message, or other notification. Such notifications may encourage other users to participate and notifications themselves may contain entry points.

In some embodiments, participation in an electronic competition may occur over a period of time. For example, a competition may be played 108. As indicated by the multiple checkboxes, participation may involve multiple sub-competitions. For example, a game may involve a number of predictions about the outcome of certain events, such as sporting events, stock prices, and the like. To play a game, users may periodically make such predictions. For instance, on one day, users may each make a prediction about a stock price, the next day the users may each make another prediction about another stock price, and so on, until the game ends.

When a game is complete, results of the game may be calculated and various participants may be notified 110, as indicated by item “5” in FIG. 1. A competition facilitator system may, for example, send electronic messages to interested participants, such as participating consumers, and sponsors. Such messages may be purely informational or may be configured (such as through an application programming interface (API) call) to invoke some action of another system, such as a wall post by a social networking system. Interested participants may be those participants who desire the outcome of the competition for some reason. A sponsor, for example, may desire the results to enable the publisher to distribute any prizes for winners of the competition or, generally, any rewards for participation which may or may not depend on being a winner of the competition. A social network may desire to know the results for updating user accounts accordingly. Other parties may desire results for other purposes, such as statistical analysis to improve advertising spending and the like.

Users who have received various prizes by playing one or more games may redeem their prizes 112. Some prizes from a single game may be redeemable without aggregation with other prizes. For example, a winner of a game may receive a discount on a product or service that is redeemable to receive the discount. Other prizes may be, by themselves, not valuable enough to be redeemed by themselves, but may be aggregated with other prizes until some minimum amount needed for redemption is collected. For example, a consumer may play a game and win a certain amount of points. The amount of points may itself not be enough for redemption of anything, but may be combined with points earned by the consumer in previous or future games. Of course, prizes that are redeemable may also be aggregated with other prizes for redemption, for example, to redeem something of even greater value.

Prize redemption may be done in numerous ways in accordance with the various embodiments. In one example, a separate entity maintains a centralized prize redemption service. Sponsors may purchase points or other prizes from the prize redemption entity which then may be awarded in a game. If not themselves valuable, the prizes may be then redeemed with the prize redemption entity, which may obtain and provide things of value in exchange for redeemed prizes. Such a prize redemption entity may also receive notifications of winners so as to track account point values and the like. In addition, a prize redemption entity may also manage distribution of the prizes themselves. For example, the prize redemption entity may maintain data that indicates how many points participants each have and may enable the participants to redeem the points. The prize redemption entity may also allocate prizes that themselves are redeemable with another entity, such as coupons or gift certificates. In another example, the sponsors may be responsible for managing distribution of prizes and redemption of redeemable prizes. A sponsor may, for example, distribute coupon or gift certificates to winners and, if applicable, manage redemption of the distributed coupons or gift certificates. The sponsor may, for instance, issue coupons that are redeemable at retail locations and/or a website of the sponsor.

As indicated by the number “6” in FIG. 1, systems in accordance with the various embodiments facilitate participation in multiple games 114. As one aspect, various participants may be provided, through one or more user interfaces, the ability to search for games of interest to participate in. Consumers may, for example, through a social network or a website of a competition facilitator or through another interface, search for games of interest, such as by submitting keywords for a keyword search. Searches may be performed based in part on other factors, such as popularity among the general public, popularity among those in a social network directly linked to the searcher, demographic factors, prize value, and the like. Similarly, one or more systems may have a recommendation engine that is configured to recommend games based on such factors. For instance, if a consumer indicates (explicitly or implicitly through interactions with one or more interfaces) an interest in a particular subject, such as college football, games relating to the subject may be recommended, advertised, or otherwise presented to the consumer. As noted, in some embodiments, consumers can participate in multiple games and can aggregate prizes toward redemption of various items which may be real and/or virtual.

Another aspect of the various embodiments of the present disclosure includes the ability of consumers to entice other consumers to participate in games. Enticement may take various forms 116, such as illustrated in item “7” of FIG. 1. For example, a consumer may, through interaction with a various user interfaces, cause invitations to participate in various games to be sent to other consumers. A user of a social networking system may, for example, issue an invitation to those directly connected to the user by the social network. The user may, for instance, select some or all of those connected to the user and, through input into the social network system, instruct the social network system to issue a notification to the selected recipients. Other tools may also be used to issue invitations to other users. For example, users may be provided a link, computer code, or other user interface component that can be included in electronic mail messages to one or more other users. As another example, a website or application (e.g. mobile application) of a competition facilitator may include an interface for inputting identifying information of other users and instructing the website or application to issue notifications to the identified users. Invitations issued in accordance with the various embodiments may, accordingly, include entry points for the users and/or links to entry points. In an embodiment, the systems may provide tools for consumers to create and manage existing or prospective competitions (such as those facilitated by, or related to, publisher content) with other consumers or prospective consumers. Such tools may include, for example, webpages, mobile and other software applications, and the like.

Embodiments of the present disclosure may also include the ability for consumers to show off their accomplishments participating in electronic competitions. As noted above, and as illustrated by item “8” of FIG. 1, various information can be posted on social network walls, can be noted in electronic communications, and can otherwise be made known to various consumers 118. Virtual (or real) prizes (such as trophies, medals, badges, and the like) may be awarded to consumers based at least in part on their accomplishments participating in electronic competitions. Leaderboards, standings, and other such information may also be posted in various locations of a website, social network interface, and the like.

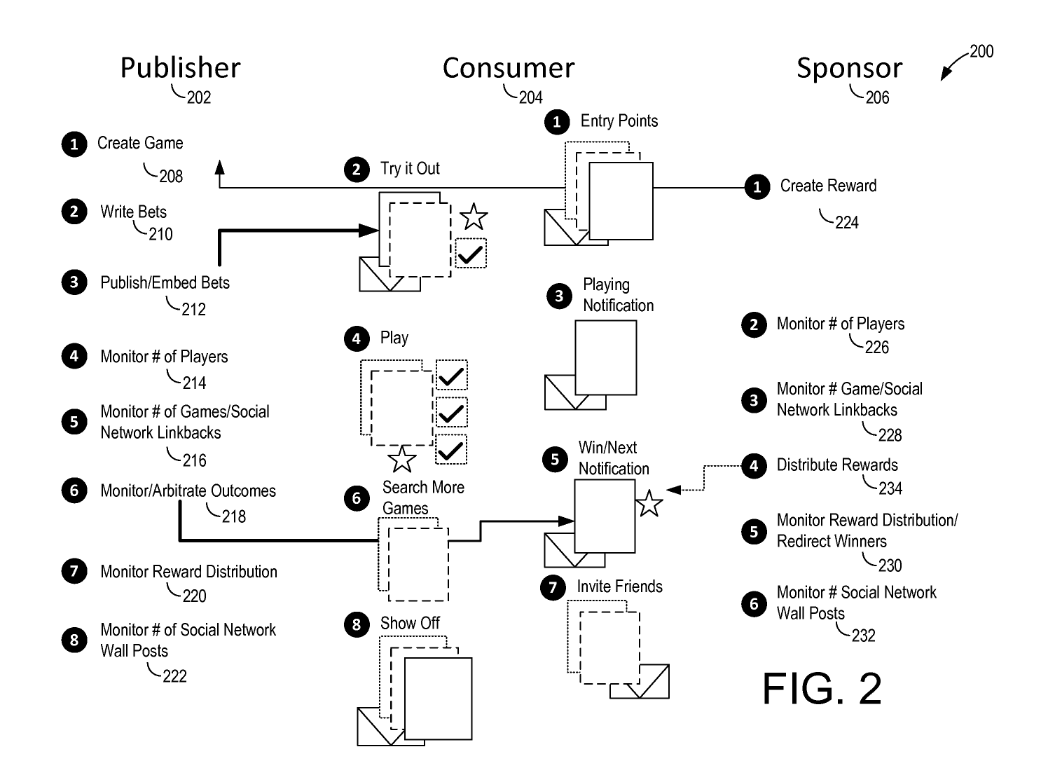

FIG. 2 shows an illustrative diagram of activities that may be performed by a publisher 202, consumer 204, and sponsor 206, in accordance with various embodiments. For example, as illustrated in FIG. 2, a publisher is able to create competitions (games) 208 to be included with content published by the publisher. Such competitions may be used by the publisher to, for example, promote, supplement or contextualize the content with which they are included. An employee of the publisher (or other person working on behalf of the publisher) may, for example, utilize a user interface to input parameters for the game. The user interface may be, for example, a web page, application, or other interface of a competition facilitator. The parameters may specify information that is displayed to players of the game, possible answers that may be selected or ranges and/or types of values that may be input, conditions for winning the game, frequency of sub-games, the number of winners allowed for the game, and the like. An example interface for creating a game is described below.

As noted, part of game creation may include specifying conditions for winning the games. In an embodiment, conditions for winning are based on objectively verifiable information from a data feed, the data feed being data provided by a trusted system, which may be a participant system or a third-party system. For example, a game may ask participants to decide whether the value of a stock will be higher or lower than a certain value at closing on a particular day. An information source that provides closing stock prices may be utilized to determine who the winners and losers are. Conditions may also be more complex. For instance, one game may be created to ask users whether the total points scored in a football game will be above or below a certain value. The winning and losing team scores may be obtained from a trusted source of sports scores and added together to determine winners and losers of the game. In addition, the possible inputs by users to play games may not be binary, but may include more than two possibilities. For instance, users may be provided with three or more choices or may be provided the ability to enter a number or other value.

Publishers, in an embodiment, also have the ability to write bets 210. A bet, as used herein, is a sub-game of a game (i.e. a competition). For example, a publisher may design a game that comprises multiple bets. The game, for example, may have one bet per day for a period of days. A game may also have a number of bets, each bet relating to a college football game on a particular Saturday. A game may be designed such that winning the game depends on how many bets are won by the various players. Further, as noted, winners of games may be determined based at least in part on objectively verifiable information from trusted data sources. Accordingly, when writing bets, a publisher may specify the data source. An example interface for designing a bet is shown below.

Once a game and its bets are designed, in an embodiment, a publisher may publish the game 212. Publishing the game may include making the game available for participation by consumers. Games, in an embodiment, may be published with an open or closed participation universe, where an open participation universe allows any participants whereas a closed universe allows only certain consumers to participate. Publishing may be performed in any suitable manner, such as by using an application or web interface to instruct a competition facilitator computer system to make a designed game available. Once available, consumers may play the game. In addition, in various embodiments, competition facilitators are able to re-use games provided by publishers in other context, such as on a web page of the competition facilitator and/or in connection with content of another publisher. The competition facilitator may, for example, a competition facilitator competition interface (e.g., web page, application) may allow users to play the game simultaneously with other users who play via a publisher interface, such as via a game embedded in a web page having publisher content. In addition, games may be used by the competition facilitator (or another entity, such as the publisher) to produce templates for other games. As an example, a game based on a prediction of a particular stock price may be used as to create a template for similar games in connection with other stock prices.

Also illustrated in FIG. 2 are various aspects of electronic competitions that the publisher may monitor. For instance, publishers may monitor the number of players 214, the number of games and social network linkbacks 216, game outcomes 218, reward distribution 220, and monitor the number of social network wall posts 222. In addition, in some embodiments, as indicated by numeral “6” in the publisher column of FIG. 2, a publisher may arbitrate game outcomes. For example, a publisher's game may have one or more bets. At an appropriate point in time, the publisher may decide who won each bet and/or each game. Deciding who won each bet may be performed in any suitable manner. For instance, a user may input data (e.g. stock price or sports score) that is determinative of the outcome or such data may be obtained in other ways, such as by querying a data source with the necessary data. The data source may be under the control of the publisher or may be a third party data source. Generally, arbitrating the outcomes of bets and/or games may be performed in any manner which enables appropriate systems involved to ascertain the outcomes of the bets and/or games and, therefore, enable the systems to proceed accordingly, such as by rewarding prizes, updating social network walls, and the like.

On the right hand side of FIG. 2 are various activities in which a sponsor may be engaged. For example, in an embodiment, sponsors are able to create rewards, such as currency or prizes 224. In some embodiments, sponsors may have the ability to select from multiple types of rewards. For instance, a sponsor may choose to create a certificate redeemable for goods or services in some instances, a discount on goods or services in other instances, and points in other instances. In some embodiments, sponsors are able to create rewards that are a combination of different reward types, such as a certificate plus a certain amount of points. Rewards may be created by sponsors in various ways. For example, a sponsor may log into a competition facilitator computer system (through a web, application, or other interface) and input information into appropriate forms that can then be submitted to enable the competition facilitator to create one or more appropriate records corresponding to the created rewards. In some embodiments, the system may facilitate the submission of creative content to, e.g., promote the rewards to consumers and prospective consumers, as well as any publisher content associated therewith. In some embodiments, the system provides or suggests relevant competitions or games to sponsors. In some of such embodiments, such suggestions are generated based on tracked metrics related to player/consumer/participant activity and/or demographic information, sponsor and/or brand performance, and the like.

As with the publisher, the sponsor may monitor various activities in connection with electronic competitions. For instance, as illustrated in FIG. 2, the sponsor is able to monitor the number of players 226, the number of games and social network linkbacks 228, rewards distribution 230, the number of social network wall posts 232, and other information relevant to the sponsor. The sponsor may also engage in various activities, such as reward distribution and redirection of winners to appropriate locations (such as web pages) for redemption of rewards 234. As noted, the various systems of different entities involved in electronic competitions of the present disclosure are configured to interact with each other to enable each participant to obtain appropriate information so that, from the point of view of each participant, the process of conducting electronic competitions is smooth. For example, each system may be configured to generate and transmit appropriate notifications in connection with competitions and reward redemption to enable each system to process such notifications and update accordingly. For example, a publisher may send a notification of outcome arbitrations to enable a system for managing rewards to update user accounts accordingly. Similarly, a game facilitator system may invoke an API of a social networking system to cause the social networking to update relevant portions of its interface for appropriate consumers accordingly.

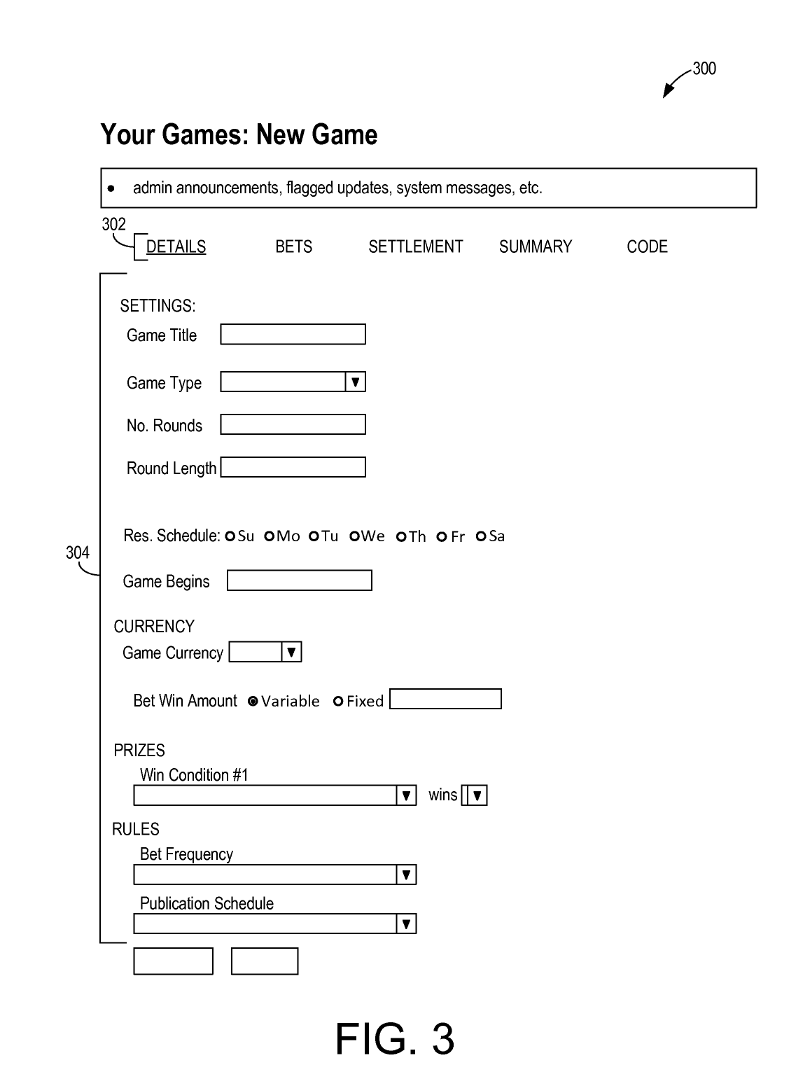

As discussed, various interfaces may be provided to enable each participant to efficiently participate in electronic competitions. FIG. 3, for example, is a sample interface of a game facilitator that may be accessed by a publisher to create a game. The interface may be accessible to the publisher through secure or other access to a web page of the competition facilitator, an application interface, and/or another interface of the competition facilitator. As illustrated in FIG. 3, the illustrative interface includes a plurality of tabs 302, a “Details” tab of which is shown as highlighted, causing a form corresponding to the “Details” tab to show. A user may, on behalf of the publisher, input information for the various fields 304 to create a game. For example, in an embodiment, as illustrated in FIG. 3, a publisher is able to input a title to the game; and select, from a plurality of game types, a number of rounds for the game, a length for each round, a day when bets of the game are resolved, a starting date for the game, a reward available to the publisher, a win amount for each bet, win conditions, rules for bet frequency and publication schedules, and other information which may vary in accordance with various embodiments.

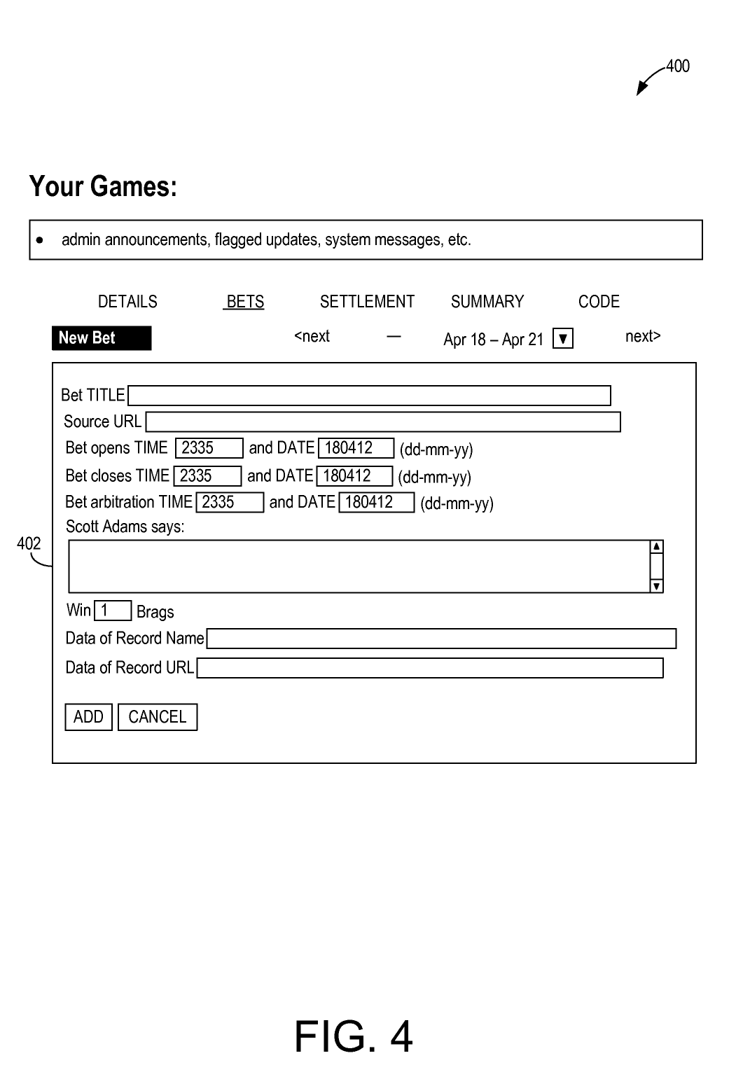

FIG. 4 shows a sample user interface screen 400 that may appear when a user selects the “Bets” tab of FIG. 3. The user interface shown in FIG. 4 may be used to create bets for a game. The user may input information for various fields of the form 402 and, as with FIG. 3, the information may be submitted in electronic form to the electronic competition facilitator for configuration of the game. The interface shown in FIG. 4 may be used numerous times by a user to create multiple bets for a game. As shown in the illustrative example of FIG. 4, the interface may include fields for a bet title, a source uniform resource locator (URL), opening and closing time and dates, a bet arbitration time, commentary, a reward for the bet, and other fields, such as a name and URL for the information source used to arbitrate the bet. A “Settlement” tab may be selected to provide information for the bet, such as how the bet was settled. For example, information regarding the winners and losers of the bets, statistics regarding the outcome of the bet, and/or other information may be presented upon selection of the “Settlement” tab.

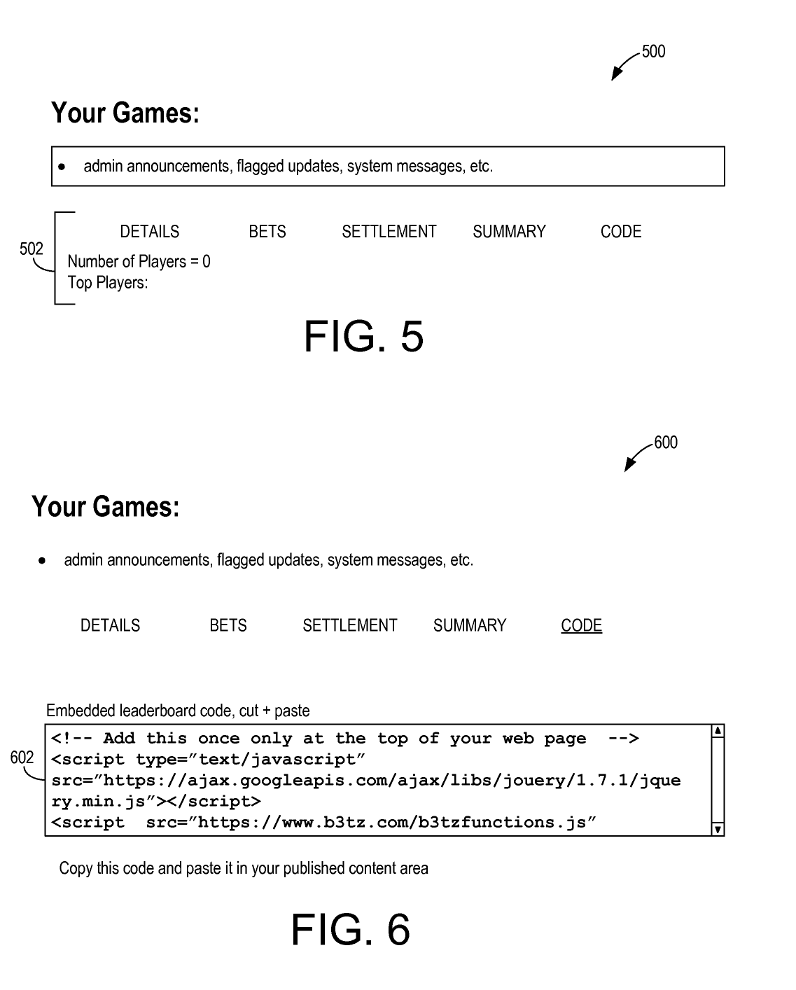

FIG. 5 shows an example 500 of how the interface of FIG. 4 may appear upon user selection of the “Summary” tab of FIG. 3 or 4. In FIG. 5, a summary of events 502 in connection with the game is shown. The summary may include information such as the number of players playing the game, identifiers for one or more top players, and/or other information. FIG. 6 shows an illustrative example 600 of the interface shown in FIG. 4 when the user selects the “Code” tab. As implied by the name of the tab, the “Code” tab, in an embodiment, includes code for the game. In an embodiment, the “code” tab includes code that the publisher can insert into its own code 602 to enable those accessing publisher content to play the game. For example, as described more below, the code may be inserted into code for a web page of the publisher so that, along with publisher content, an entry point or link to an entry point of the game is presented. As shown in FIG. 6, a user associated with the publisher may cut and paste code from the interface of FIG. 6 into web page code of the publisher. Other ways are also considered as being within the scope of the present disclosure. For example, the publisher may be configured to automatically call an API of the competition facilitator in a process for automatically or semi-automatically generating code for a web page. The content itself may be used to locate, through a search engine or in another way, an applicable game and obtain and insert code automatically. For example, content from an article about a company may be used to identify a game that is based on the company's stock price. It should also be noted that the competition facilitator (or another entity) may utilize game templates to dynamically generate games. For example, an automated process may analyze an article's content to identify a company identifier which may be used as input into a function that generates a game based on some aspect of the company, such as its stock price. Other examples are also considered as being within the scope of the present disclosure.

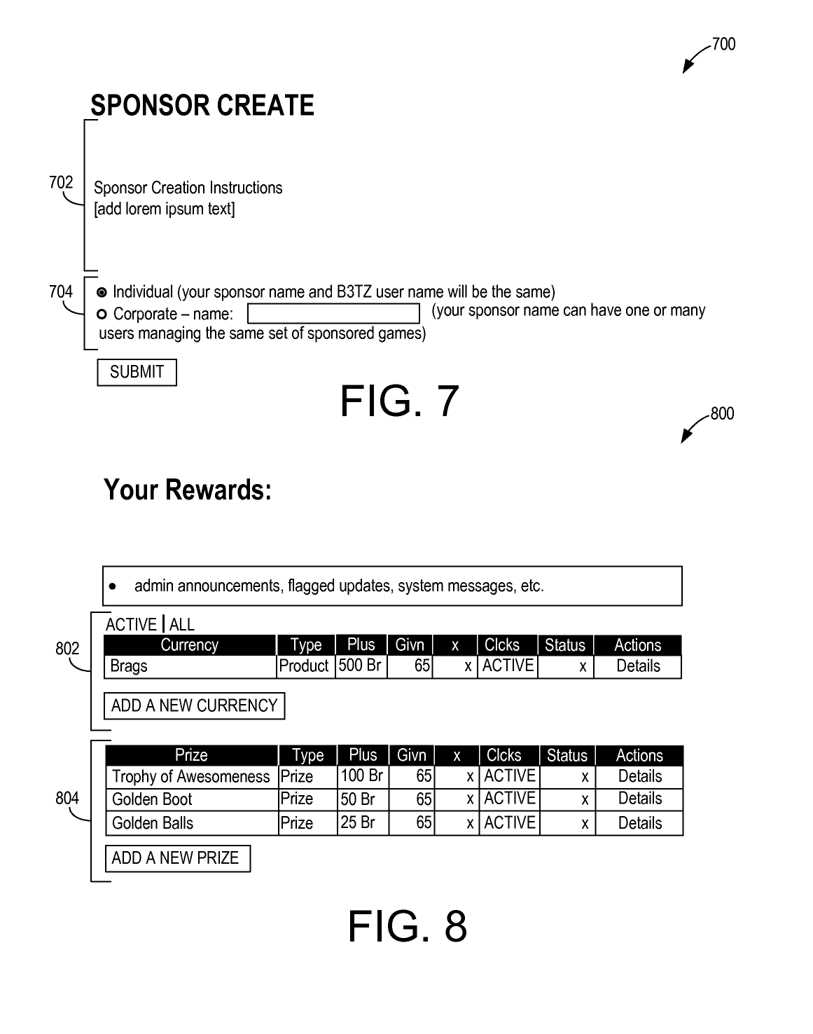

As noted, sponsors are able to create rewards in accordance with various embodiments. FIG. 7, accordingly, shows an illustrative example 700 of a user interface page that a sponsor may utilize to create a reward. The user interface may be provided in the same or a similar manner as discussed above, such as through an application and/or web page. In FIG. 7 some general information 702 is given to the sponsor and the sponsor is able to select a sponsor type 704. In this example, the selectable sponsor types are individual or corporate. It should be noted that such types are provided for the purpose of illustration and that other types may be possible in various embodiments. As shown, once a sponsor type is selected, the user may submit the choice to cause an appropriate interface to appear.

FIG. 8 shows an illustrative example of an interface 800 that may appear upon selecting “Submit” in the interface of FIG. 7. In the interface shown in FIG. 8, the user has the ability to add both currencies 802 and prizes 804. A currency may be, for example, points that are earned by playing games and that can be aggregated over the participation in multiple games. Currency, as described above, may be redeemable for items of value, such as goods and services, although some embodiments may utilize a currency that is not redeemable for anything of value. A prize may be some sort of electronic representation of something of value that is given to one or more winners of a game. Example prizes include electronic trophies, badges, medals, and the like. A competition facilitator system (and/or other system) may include a data store that associates users with prizes that have been won. A social networking system or other system may be used to allow users to show off prizes they have won. A user's page on a social networking website may, for instance, include some sort of visual indication that the user has obtained one or more prizes.

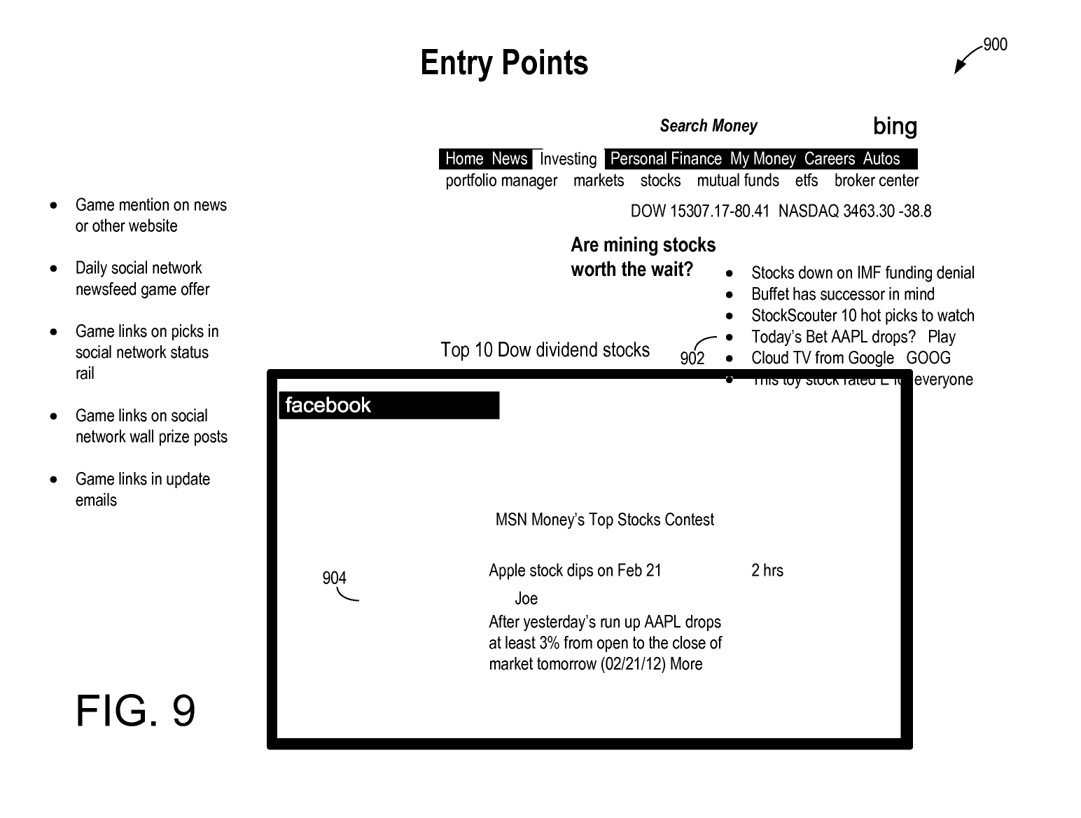

As noted above, various entry points may be provided to consumers to enable the consumers to engage in electronic competitions. FIG. 9 shows two examples 900 of entry points that may be available to consumers. In one example, an entry point is accessible through a link 902, such as hyperlinked text on a web page. In this example, a user may select “Today's Bet AAPL drops?| Play” to navigate to a page that allows the user to participate in a competition that includes that bet. If the user has an existing account with a corresponding competition facilitator that and is already authenticated with the competition facilitator, the user may navigate directly to a page that allows the user to play the game. If the user is not authenticated, the user may be presented a page that asks for login credentials or may allow the user to create an account with the competition facilitator (or an entity that utilizes the competition facilitator's system as a backend for holding electronic competitions).

Also shown in FIG. 9 is an entry point 904 provided to a consumer through a social network web page. In this example, the entry point appears as an item in a news feed of the social network and, because the consumer is already authenticated with the social network, the user is able to play the game directly from the news feed entry by selecting “Agree” or “Disagree.” In an embodiment, selecting “Agree” or “Disagree” causes an electronic notification to be sent to an appropriate system (such as a competition facilitator system) to register the choice and maintain statistics about the game accordingly. Generally, entry points may be made accessible in any suitable manner, such as through mentions in web or other content, through advertisements in web content or mobile applications or other applications, in electronic mail, and the like.

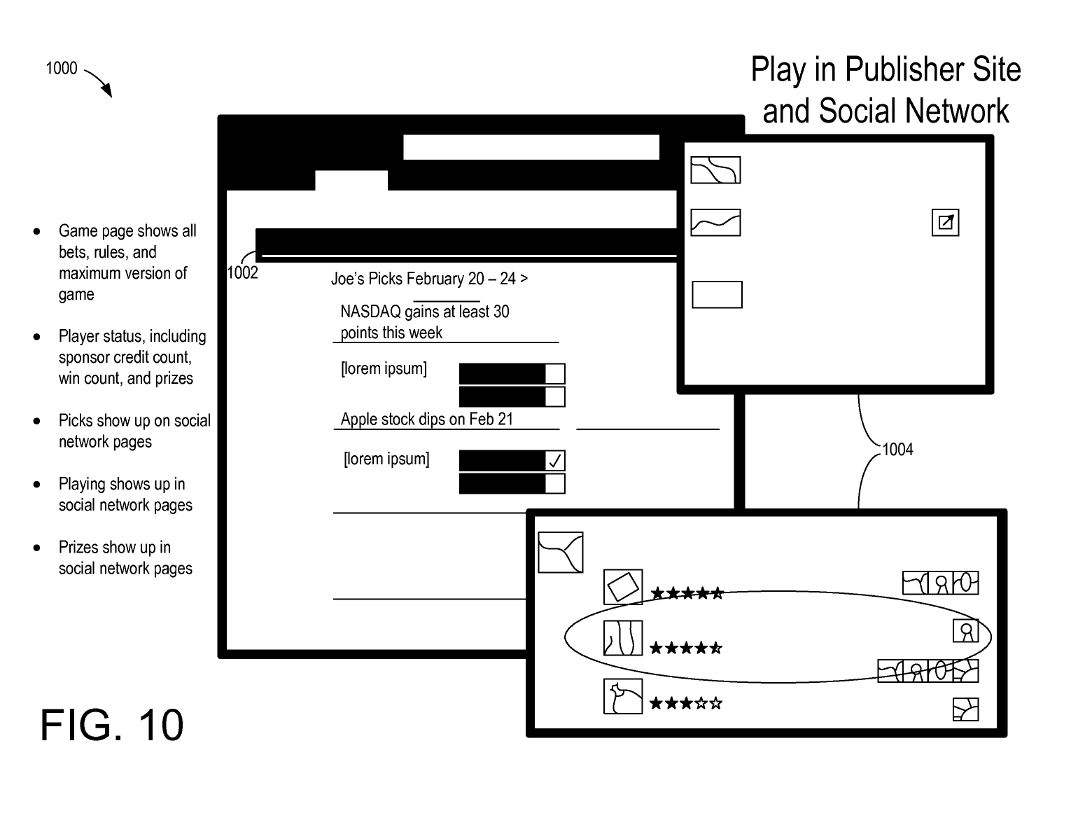

The games themselves may also be presented in various ways, in accordance with the various embodiments. For example, FIG. 10 shows an illustrative example 1000 of one way in which games may be presented to consumers. In this example, a publisher website has a web page directed to a Money Bet Game 1002. The page presents various information provided by various other systems that are, for the purpose of electronic competitions, integrated with the publisher system. For example, as illustrated in FIG. 10, code for the web page of the Money Bet Game may include code that accesses content from a social network system which, in turn, includes content that was generated by a competition facilitator system that utilizes APIs and other tools of the social network system. In this illustration, information 1004 about who played the game, how the game was played, scores, and the like are presented on the page. Entry points are also illustrated on the page to enable a user visiting the page to play the game. Cookies and other mechanisms may enable applicable systems to identify the user so as to allow the user to play when in an authenticated state.

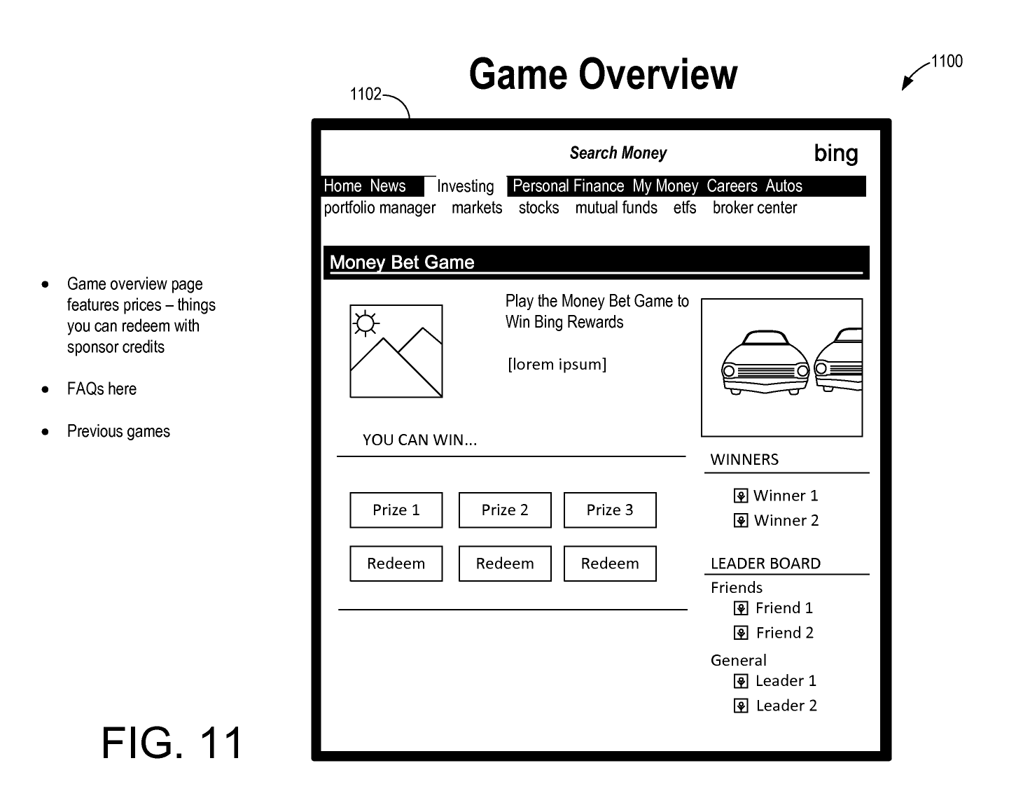

FIG. 11 shows an illustrative example 1100 of a Game Overview page 1102 which may be produced by a publisher, in accordance with an embodiment. The Game Overview page, in this example, presents information about the games, prizes that can be redeemed with rewards won (and possible aggregated from playing other games), rules, and the like.

It should be noted that various embodiments described herein are provided for the purpose of illustration and that numerous variations are within the scope of the present disclosure. For example, illustrative embodiments described herein illustrate various aspects in connection with four separate entities: consumers; competition facilitators; publishers; and sponsors. While presented as separate entities, subsets of these entities may be combined. For example, a publisher and competition facilitator may be the same entity and may also be the sponsor. In addition, other entities may also play other roles which are not necessarily explicitly described herein.

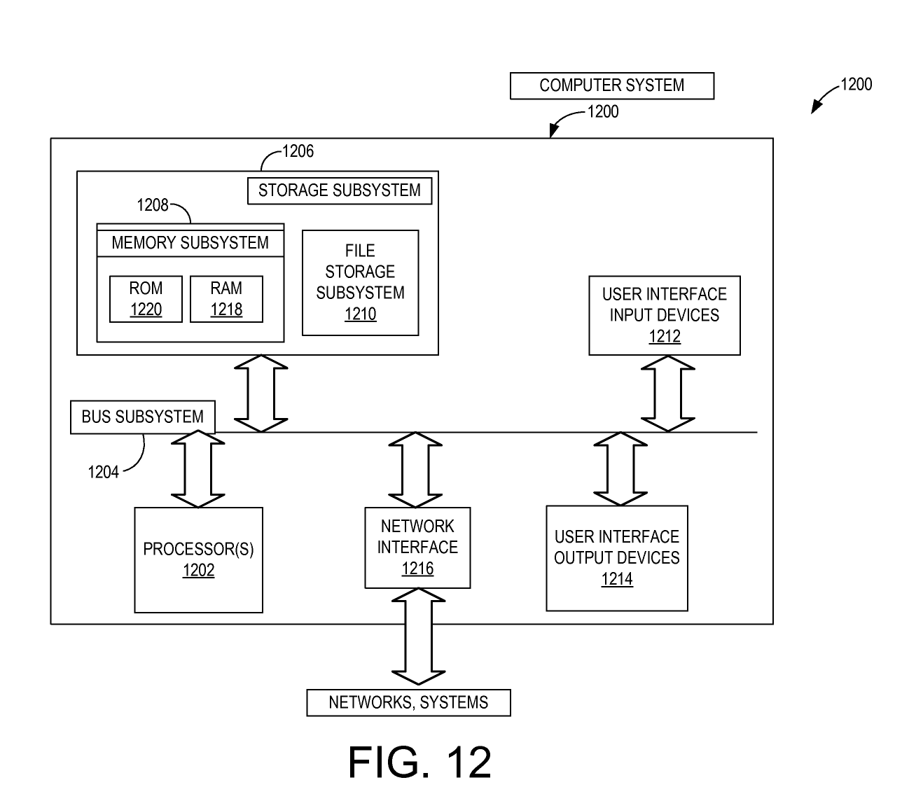

Embodiments of the present disclosure may be implemented with a variety of various systems. FIG. 12 is a simplified block diagram of a computer system 1200 that may be used to practice embodiments of the present invention. In various embodiments, computer system 1200 may be used to implement any of the systems illustrated and described above. For example, computer system 1200 may be used to implement processes for creating, managing, participating, sponsoring, or otherwise participating in electronic competitions. As shown in FIG. 12, computer system 1200 includes a processor 1202 that communicates with a number of peripheral subsystems via a bus subsystem 1204. These peripheral subsystems may include a storage subsystem 1206, comprising a memory subsystem 1208 and a file storage subsystem 1210, user interface input devices 1212, user interface output devices 1214, and a network interface subsystem 1216.

Bus subsystem 1204 provides a mechanism for enabling the various components and subsystems of computer system 1200 to communicate with each other as intended. Although bus subsystem 1204 is shown schematically as a single bus, alternative embodiments of the bus subsystem may utilize multiple busses.

Network interface subsystem 1216 provides an interface to other computer systems and networks. Network interface subsystem 1216 serves as an interface for receiving data from and transmitting data to other systems from computer system 1200. For example, network interface subsystem 1216 may enable a user computer to connect to the Internet and facilitate communications using the Internet. Network interface subsystem 1216, as another example, may allow the computer system 1200 to operate as a server to provide information in responsive to requests and other communications from other computer systems.

User interface input devices 1212 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 1200. In addition, in some uses, the computer system may not utilize an input device. For example, the computer system 1200 may be in a server rack that does not have an input device for the computer system 1200. In addition, the input device may control the computer system 1200 remotely, through a communications network such as the Internet.

User interface output devices 1214 may, but does not necessarily, include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 1200. Information relevant to creating, managing, playing, sponsoring, or otherwise participating in electronic competitions may be output by computer system 1200 using one or more of user interface output devices 1214.

Storage subsystem 1206 provides a computer-readable storage medium for storing the basic programming and data constructs that provide the functionality of the present invention. Software (programs, code modules, instructions) that when executed by a processor provide the functionality of the present invention may be stored in storage subsystem 1206. These software modules or instructions may be executed by processor(s) 1202. Storage subsystem 1206 may also provide a repository for storing data used in accordance with the present invention. Storage subsystem 1206 may comprise memory subsystem 1208 and file/disk storage subsystem 1210. Storage subsystem 1206 may be used to store records for games, players, and to store information relevant to such. Storage subsystem 1206 may, for example, store data for a relational database that associates players, games, and relevant information.

Memory subsystem 1208 may include a number of memories including a main random access memory (RAM) 1218 for storage of instructions and data during program execution and a read only memory (ROM) 1220 in which fixed instructions are stored. File storage subsystem 1210 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 1200 can be of various types including a personal computer, a portable computer, a workstation, a network computer, a mainframe, a kiosk, a server, a mobile communications device, a table computer system, or any other data processing system. Due to the ever-changing nature of computers and networks, the description of computer system 1200 depicted in FIG. 12 is intended only as a specific example for purposes of illustrating the preferred embodiment of the computer system. Many other configurations having more or fewer components than the system depicted in FIG. 12 are possible.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for facilitating participation in interactive content, comprising:
under the control of one or more computer systems configured with executable instructions,
providing one or more electronic competitions capable of being associated with electronic content;
providing a publisher interface that enables a publisher to define associations between a subset of the electronic competitions and a subset of the electronic content; and
upon receiving the associations via the publisher interface, presenting the associated subset of the electronic competitions and the subset of the electronic content so as to promote the subset of the electronic content to a plurality of consumers.

2. The method of claim 1, wherein the publisher interface further enables the publisher to customize the competition content of the associated subset of electronic competitions.

3. The method of claim 2, wherein the competition content includes one or more sub-competitions.

4. The method of claim 1, wherein the subset of electronic competitions is associated with the subset of electronic content by at least visually integrating the subset of electronic competitions with the subset of electronic content.

5. The method of claim 1, wherein the associated subset of electronic content is promoted to the plurality of consumers by enabling the consumers to interact with the subset of electronic competitions.

6. The method of claim 5, further comprising providing the consumers with one or more incentives to interact with the electronic competitions.

7. The method of claim 6, wherein the incentives include at least one of prizes or currency redeemable for the prizes.

8. The method of claim 6, wherein the incentives are provided to a subset of the consumers at a time after the subset of consumers meets or exceeds one or more conditions defined by the publisher, the conditions associated with the subset of consumers' interactions with the subset of electronic competitions.

9. The method of claim 5, further comprising providing a consumer interface that enables the consumers to view the consumers' past interactions with the subset of electronic competitions.

10. The method of claim 5, further comprising providing a consumer interface that enables the consumers to initiate and view interactions with other consumers via the subset of electronic competitions.

11. The method of claim 5, wherein the incentives are provided by one or more sponsors.

12. The method of claim 11, wherein the sponsors and the publishers are separate entities.

13. The method of claim 11, further comprising providing a sponsor interface that enables sponsors to provide incentive information relating to the incentives.

14. The method of claim 13, wherein the sponsor interface further enables the sponsors to associate incentives with electronic competitions.

15. The method of claim 14, wherein the incentive information includes sponsor-generated content to be presented in connection with the associated electronic competitions.

16. The method of claim 14, further comprising providing the sponsors with suggestions for associations between the incentives and the electronic competitions.

17. A content participation system, comprising:
one or more processors;
memory, including instructions executable by the one or more processors to cause the system to at least:
provide one or more electronic games capable of being associated with electronic content;
provide a publisher interface that enables publishers to at least:
associate a subset of the electronic games and a subset of the electronic content, and
customize content of the subset of electronic games;
provide a sponsor interface that enables sponsors to at least:
define incentives associable with the electronic games;
receive suggestions for one or more of the electronic games with which to associate the defined incentives; and
provide information related to the defined incentives, the provided information including one or more associations between the defined incentives and the electronic games;
provide a customer interface that enables customers to at least:
view the customers' past interaction with the electronic games; and
initiate contact with other customers through the electronic games; and
facilitate customer interaction with the publisher-associated subsets of electronic content by enabling the display of the publisher-associated subsets of electronic games and the defined incentives associated with the electronic games in the publisher-associated subset of electronic games in conjunction with the subset of electronic content.
